(19) United States
(12) Patent Application Publication
(10) Pub. No.: US 2013/0204648 A1
(43) Pub. Date: Aug. 8, 2013

(54) MANAGEMENT APPARATUS AND MANAGEMENT METHOD

(71) Applicants: Takayuki Natsume, Tokyo (JP); Kengo Shinoda, Tokyo (JP); Takuya Hashimoto, Tokyo (JP)

(72) Inventors: Takayuki Natsume, Tokyo (JP); Kengo Shinoda, Tokyo (JP); Takuya Hashimoto, Tokyo (JP)

(73) Assignee: KONAMI DIGITAL ENTERTAINMENT CO., LTD., Minato-ku, Tokyo (JP)

(21) Appl. No.: 13/878,140

(22) PCT Filed: Jun. 1, 2012
(86) PCT No.: PCT/JP2012/064260

§ 371 Date: Apr. 5, 2013

(30) Foreign Application Priority Data
Jun. 3, 2011 (JP) 2011-125293

(51) Int. Cl. G06Q 10/02

(52) U.S. Cl. CPC G06Q 10/02
USPC 705/5

(57) ABSTRACT

A golf course server manages the reservation status of player openings intended for members by using a reservation file. The management apparatus accesses the reservation file to acquire offer start time information. When an offer start time has come, the management apparatus accesses the reservation file again to acquire availability information, so that the management apparatus releases an offer page generated based on the acquired availability information on the Internet to offer a reservation for use of a service.

### TECHNICAL FIELD

The present invention relates to techniques for reservation support systems and the like provided for general membership services sites and social networking services (SNS) sites.

### BACKGROUND ART

A golf course prioritizes reservations from members (of the golf course) who have the right to use the golf course. However, player openings at the golf course may not be fully booked by only reservations from members. For this reason, while securing player openings for members, the golf course may make public offerings of reservations for other player openings in advance.

Internet service for such reservation support is known (see Patent document 1). In this reservation support service, guidance information on a golf competition is sent from a golf course server to a carrier server. The guidance information is sent to a user terminal when the user terminal accesses the carrier server. The user considers whether or not to participate in the competition by referring to the guidance information. When deciding to participate, the user sends selection information to the carrier server. Then, the carrier server executes the reservation at the golf course server.

### CITATION LIST

Patent Document

Patent document 1: JP 2002-222288 A

### SUMMARY OF INVENTION

Technical Problem

Generally, conditions for the player openings being secured for members, such as a starting time of play, and a course order of play, are often good compared with those of the player openings offered to the public.

However, since information on the player openings for members is made available to a limited degree, the golf course often ends up not being fully booked.

Therefore, an object of the present invention is to improve the probability of fixing reservations for use of services, such as golf courses, accommodations, concerts, and the like.

Solution to Problem

A measure employed in the present invention to solve the problem will be described below. A management apparatus adapted for receiving a reservation to communicate with a server device updating a reservation file, in which availability information indicating an opening for a reservation for use of a service is recorded, wherein the management apparatus generates offer information on an offer of the reservation for use of the service to provide the offer information through a communication network, and the management apparatus further receives a request for the reservation for use of the service from a member to fix the reservation, the management apparatus including: a first acquisition unit adapted for accessing the reservation file in the server device to acquire offer start time information, which is recorded in the reservation file, and indicates a time from which the offer is available in the management apparatus; a second acquisition unit adapted for accessing the reservation file in the server device to acquire the availability information after the elapse of the time indicated by the acquired offer start time information; an offer information providing unit adapted for generating the offer information, in which is indicated content of the service, and the availability of the reservation for use of the service, based on the availability information acquired by the second acquisition unit, and for providing the offer information through the communication network; and a reservation fixing unit adapted for receiving reservation request information, which indicates a reservation request for requesting a reservation for use of the service, from a communication device of the member, and for, if the reservation request is accepted, changing a status of the availability specified in the reservation request information from an available status to a reserved status to fix the reservation.

The term “service” may be any services as long as it is reserved and used, including, for example, play at a golf course, accommodations, and concerts. The phrase “accessing a reservation file” may be conducted by any method as long as content of the reservation file can be accessed, including, for example, an aspect in which an access request for the reservation file is sent to the server device and in which an access response is received by the management apparatus, or an aspect in which so-called access control is used to view contents of the reservation file from the management apparatus.

Another management apparatus according to the present invention, being adapted for receiving a reservation to communicate with a server device updating a reservation file, in which availability information indicating availability of a reservation for use of a service is recorded, wherein the management apparatus generates offer information on an offer of the reservation for use of the service to provide the offer information through a communication network, and the management apparatus further receives a request for the reservation for use of the service from a member to fix the reservation, the management apparatus including: a first acquisition unit adapted for accessing the reservation file in the server device to acquire the use start time information, which is recorded in the reservation file, and indicates a time from which the use of the service is available in the management apparatus; a second acquisition unit adapted for accessing the reservation file in the server device to acquire the availability information at a predetermined time before the time indicated by the acquired use start time information; an offer information providing unit adapted for generating offer information, which indicates contents of the service, and the availability of the reservation for use of the service, based on the availability information acquired by the second acquisition unit; and a reservation fixing unit adapted for receiving reservation request information, which indicates a reservation request for requesting a reservation for use of the service, from a communication device of the member, and for, if the reservation request is accepted, changing a status of the availability specified in the reservation request information from an available status to a reserved status to fix the reservation.

Preferably, the above-mentioned management apparatus, in which the first acquisition unit acquires the availability information together with the offer start time information or the use start time information, the management apparatus further including: a third acquisition unit adapted for accessing the reservation file to acquire the availability information during a period from a time when the first acquisition unit acquires the availability information to a time when the second acquisition unit acquires the availability information; and a notification unit adapted for notifying the member of information indicating a possibility of the offer of the reservation for use in the service, the possibility being determined at least based on the availability information acquired by the third acquisition unit.

In the above-mentioned management apparatus, the second acquisition unit preferably removes access to the reservation file when the availability information acquired by the third acquisition unit indicates that all places in the service are reserved.

A management method according to the present invention, executed by a management apparatus adapted for receiving a reservation to communicate with a server device updating a reservation file, in which availability information indicating availability of a reservation for use of a service is recorded, wherein the management apparatus generates offer information on an offer of the reservation for use of the service to provide the offer information through a communication network, and the management apparatus further receives a request for the reservation for use of the service from a member to fix the reservation, the management method including: accessing the reservation file in the server device to acquire offer start time information, which is recorded in the reservation file, and indicates a time from which the offer is available in the management apparatus; accessing the reservation file in the server device to acquire the availability information after the elapse of the time indicated by the acquired offer start time information; generating the offer information, which indicates contents of the service, and the availability of the reservation for use of the service, based on the availability information acquired by the second acquisition unit; providing the offer information through the communication network; receiving reservation request information, which indicates a reservation request for requesting a reservation for use of the service, from a communication device of the member; and if the reservation request is accepted, changing a status of the availability specified in the reservation request information from an available status to a reserved status to fix the reservation.

Another management method according to the present invention, executed by a management apparatus adapted for receiving a reservation to communicate with a server device updating a reservation file, in which availability information indicating availability of a reservation for use of a service is recorded, wherein the management apparatus generates offer information on an offer of the reservation for use of the service to provide the offer information through a communication network, and the management apparatus further receives a request for the reservation for use of the service from a member to fix the reservation, the management method including: accessing the reservation file in the server device to acquire the use start time information, which is recorded in the reservation file, and indicates a time from which the use of the service is available in the management apparatus; accessing the reservation file in the server device to acquire the availability information at a predetermined time before the time indicated by the acquired use start time information; generating offer information, which indicates contents of the service, and the availability of the reservation for use of the service, based on the availability information acquired by the second acquisition unit; receiving reservation request information, which indicates a reservation request for requesting a reservation for use of the service, from a communication device of the member; and if the reservation request is accepted, changing a status of the availability specified in the reservation request information from available status to reserved status to fix the reservation.

### BRIEF DESCRIPTION OF THE DRAWINGS

FIG. 1 shows a block diagram of a reservation support system according to a first embodiment of the present invention.

FIG. 2 shows an explanatory view showing one example of a data structure of a reservation file 4fa.

FIG. 3 shows a block diagram showing a function of a management apparatus.

FIG. 4 shows a block diagram showing a configuration of the management apparatus.

FIG. 5 shows an explanatory view showing a data structure of an SNS member database DB.

FIG. 6 shows an explanatory view showing one example of a sequence of requesting an offer.

FIG. 7 shows an explanatory view showing one example of an offer page for requesting an offer.

FIG. 8 shows an explanatory view showing one example of a sequence of an automatic offer.

FIG. 9 shows an explanatory view showing one example of a reservation file 4fa contained in a reservation file access response Y2.

FIG. 10 shows an explanatory view showing one example of an offer page for an automatic offer.

FIG. 11 shows an explanatory view showing one example of a data structure of a reservation file 4fb according to a second embodiment of the present invention.

FIG. 12 shows an explanatory view showing another example of the sequence of an automatic offer.

FIG. 13 shows a block diagram showing a variation of the function of the management apparatus.

FIG. 14 shows an explanatory view showing a variation of the sequence of an automatic offer.

FIG. 15 shows an explanatory view showing a variation of the sequence of an automatic offer.

FIG. 16 shows an explanatory view showing a variation of the sequence of an automatic offer.

FIG. 17 shows an explanatory view showing a variation of the sequence of an automatic offer.

### DESCRIPTION OF EMBODIMENTS

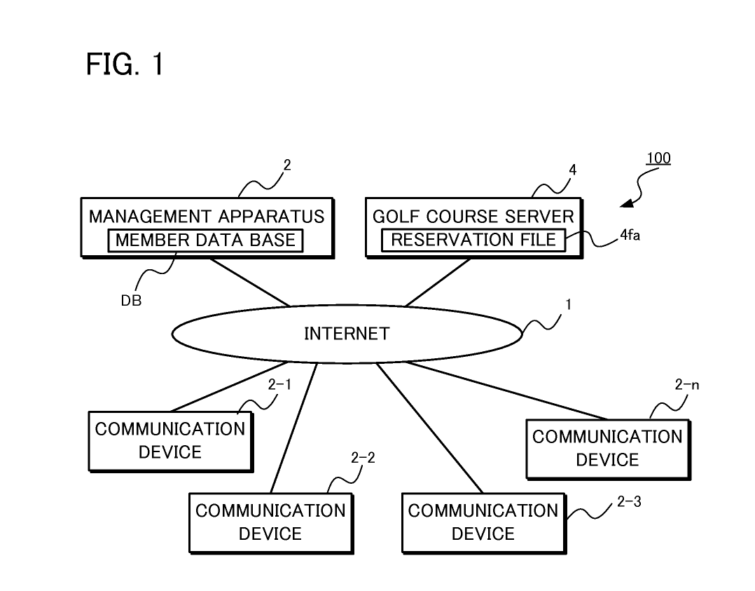

1. First embodiment FIG. 1 shows a block diagram 100 of a reservation support system according to a first embodiment of the present invention. This reservation support system 100 supports a reservation of a player opening from a member of SNS. As one example of the reservation support system, a reservation support system for a golf course, which is intended for the members of SNS, is shown.

The reservation support system 100 is provided with communication devices 2-1, 2-2, 2-3 . . . 2-n of the members of SNS, a management apparatus 3 managing a reservation of a place in a service, a golf course server 4, and an Internet 1 serving as a communication network. The communication devices 2-1 . . . 2-n of the members of SNS are able to communicate through the Internet 1, which are provided with a browser function and an e-mail function, and corresponds to a personal computer and a mobile phone, for example.

The golf course server 4 is a server maintained by an administrator in a golf course, which provides information on an offer of a reservation for a play opening to the management apparatus 3. This enables the golf course to outsource an offer of the reservation. In the golf course, a reservation from a member who has the right to use the golf course is received through a telephone, a facsimile, e-mail, or the golf course server 4. For this reason, while player openings for the members are secured in advance, offerings of reservations for other player openings may be made to the public.

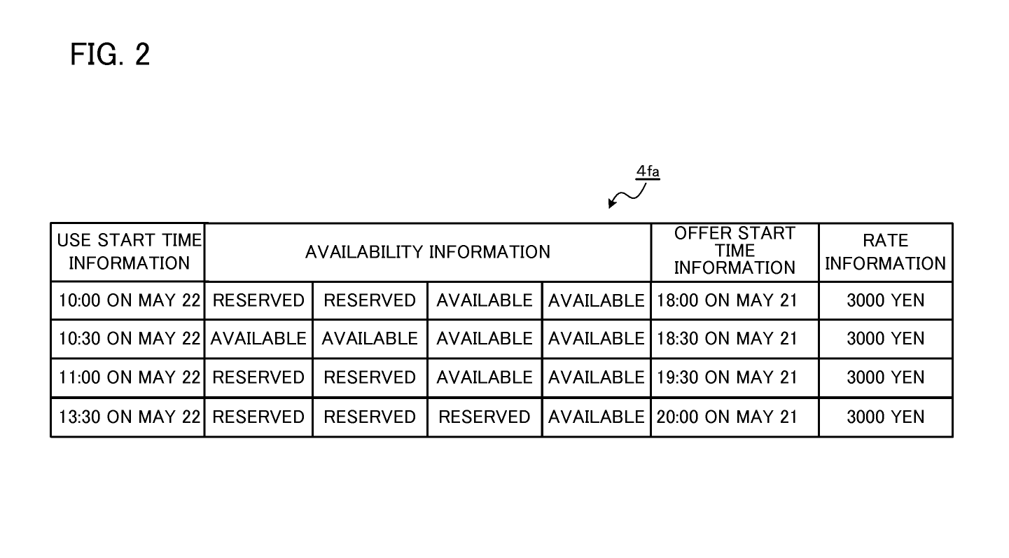

The golf course server 4 is provided with a memory unit storing a reservation file 4fa. In the reservation file 4fa, information indicating reservation statuses of the play openings secured for the members of the golf course are recorded. FIG. 2 shows the data structure of the reservation file 4fa. The reservation file 4fa has multiple records. In each of the records, use start time information indicating a starting time of play, availability information indicating availability of a player opening, offer start time information indicating an offer start time from which an offering to the public is available, and rate information indicating a rate applied to each player opening are associated with each other and recorded. The offer start time is a time when an offering of a reservation is made public after an acceptance of the reservation from the members of the golf course is ended for the golf course. The administrator of the golf course server 4 writes the records of the reservation file 4fa.

The management apparatus 3 provides the members of SNS information on an offering of a reservation for use of services being intended for the members of SNS. The service includes play in a golf course, accommodation, and concerts.

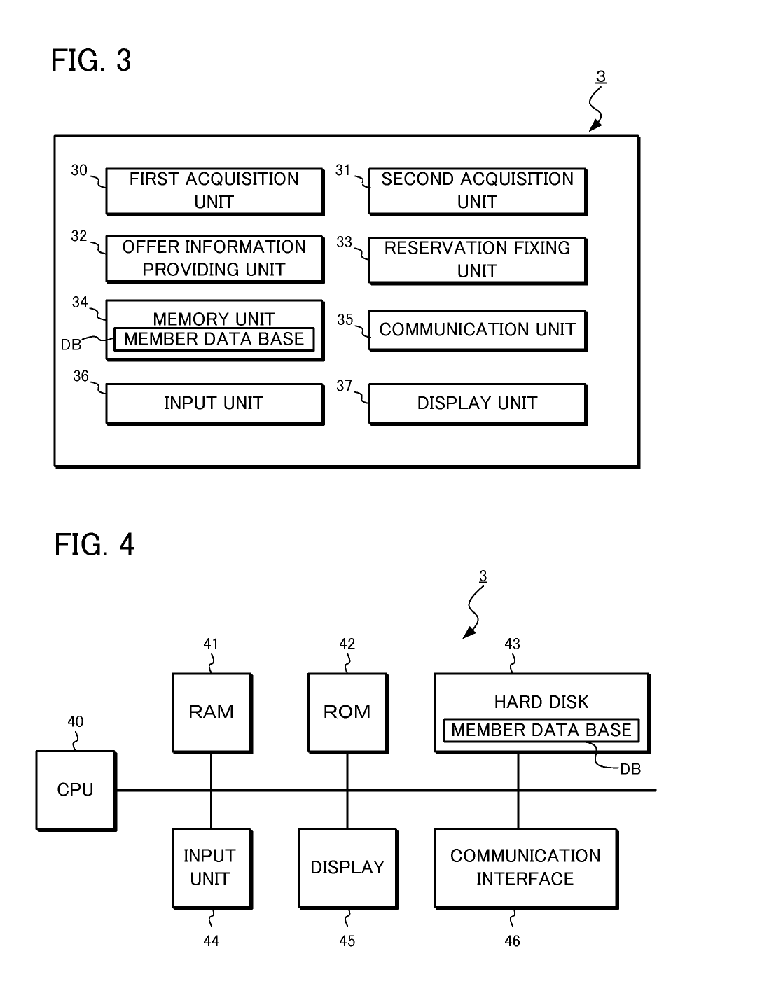

The function of the management apparatus 3 will be described in reference to FIG. 3. As shown in this figure, the management apparatus 3 is provided with a first acquisition unit 30, a second acquisition unit 31, an offer information providing unit 32, a reservation fixing unit 33, a memory unit 34, a communication unit 35, an input unit 36, and a display unit 37.

The first acquisition unit 30 accesses the reservation file 4fa to acquire the offer start time information. The second acquisition unit 31 accesses the reservation file 4fa to acquire the availability information after an elapse of a time indicated by the acquired offer start time information. The offer information providing unit 32 generates offer information indicating contents of a service, and availability for use of the service based on the acquired availability information to provide the offer information through the Internet 1. When the reservation fixing unit 33 receives reservation request information indicating a reservation request for use of the service from communication devices 2-1 . . . 2-n of the members of SNS, and accepts the reservation request, the reservation fixing unit 33 changes a status of the availability for the service specified in the reservation request information from “available” to “reserved” to fix the reservation. The first acquisition unit 30, the second acquisition unit 31, the offer information providing unit 32, and the reservation fixing unit 33 are functional blocks achieved by functioning according to a computer program executed by a central processing unit (CPU) shown in FIG. 4. The memory unit 34 includes, for example, a hard disk or the like, which stores various programs and data. The communication unit 35 communicates with an external device through the Internet 1. The input unit 36 includes a keyboard and a mouse. The display unit 37 includes a display and the like, which displays images. The memory unit 34 stores the SNS member database DB. The management apparatus 3 may include multiple servers to provide a server that manages the reservation for use for the service, and a server that provides the SNS member database DB independently.

FIG. 4 shows the structure of the management apparatus 3. As shown in this figure, the management apparatus 3 is provided with a central processing unit (CPU) 40, which controls the entire device, a random access memory (RAM) 41, which serves as the work area of the CPU 40, a read only memory (ROM) 42, which stores a boot program and the like, a hard disk 43, which stores various programs and data, an input unit 44, which includes a keyboard and a mouse, a display 45, which displays images, and a communication interface 46, which communicates with an external device through the Internet 1.

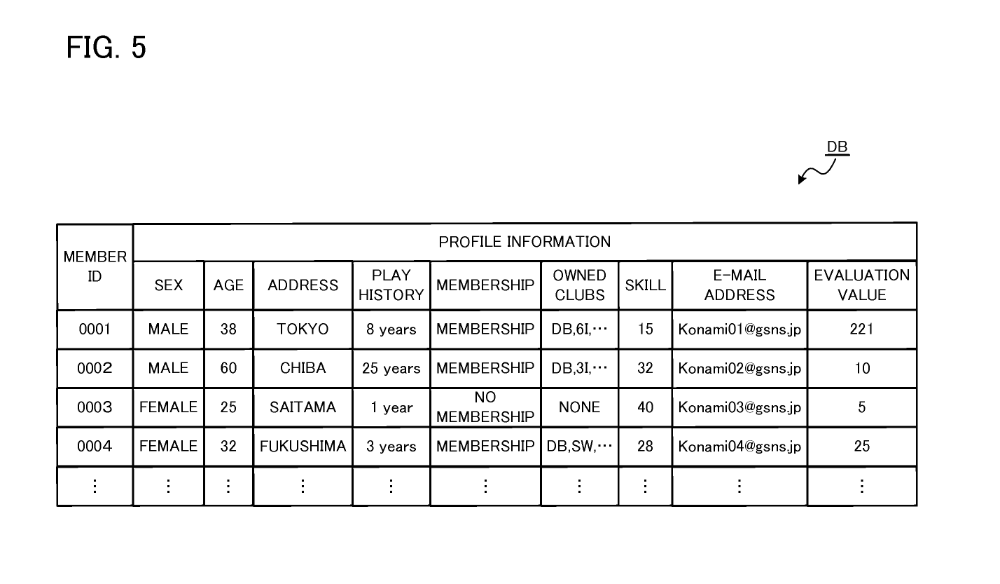

FIG. 5 shows a part of a data structure of data stored in the SNS member database DB. As shown in this figure, in the SNS member database DB, member identification (ID) information, which uniquely identifies each member of the SNS, and profile information, are associated with each other and recorded. In the profile information, sex, age, address, a golf play history, membership or no membership of a golf course, owned clubs, skill, e-mail address, and an evaluation value are associated with each member ID and stored. The skill means a golf handicap. The evaluation value is a cumulative value evaluated for manners and likability of an evaluated member after play by a member of the SNS who has played golf together with the evaluated member. For example, the evaluation is conducted by grading the manners and likability on the point scale: “2” for “very good,” “1” for “good,” “0” for “normal,” “−1” for “poor,” and “−2” for “very poor.”

About the action of the reservation support system 100, an offer request and an automatic offer will be described separately.

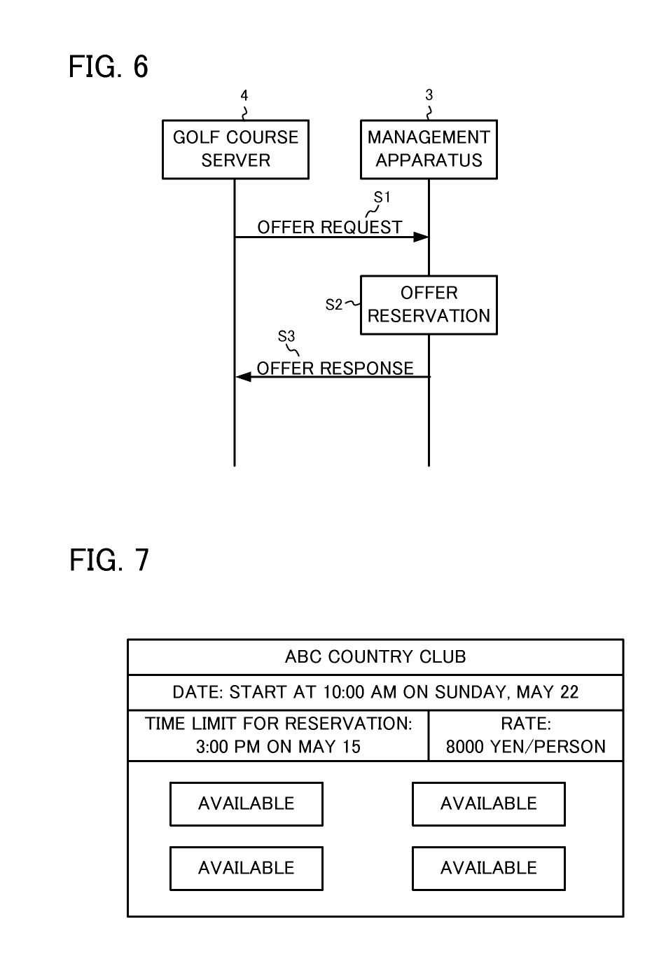

FIG. 6 shows the sequence of requesting an offer. As shown in this figure, an offer request is sent from the golf course server 4 to the management apparatus 3 (S1). The management apparatus 3 provides information indicating an offer of a reservation for use of the service based on the offer request through the Internet 1 (S2). In this case, the information may or may not be provided exclusively to the members of the SNS. When the information may not be provided exclusively to the members of the SNS, a non-member of the SNS can access the content of the service, which can provide motivation to sign up as a member of the SNS.

The offer request contains offer information indicating a name of a golf course, a scheduled date and time, a time limit for the reservation, the number of persons, and a rate per person. When the offer information indicates that, as shown in FIG. 7, the name of the golf course is “ABC country club,” the date is “Start at 10:00 AM on Sunday, May 22,” the time limit for the reservation is “3:00 PM on May 15,” the number of persons is “four,” the rate per person is “8000 yen,” the management apparatus 3 releases information including for example, player openings corresponding to the number of persons, who are available for use of the service, and the rate set for each of the player openings (in this example, a single rate of 8000 yen) through the Internet 1. This enables the members of the SNS to know that the reservation for use of the service is offered.

After offering the reservation for use of the service, the management apparatus 3 sends an offer response indicating that the offer has been started, back to the golf course server 4 (S3) as shown in FIG. 6. In this way, when receiving the offer request from the golf course server 4, the management apparatus 3 executes the offer of the reservation for use of the service.

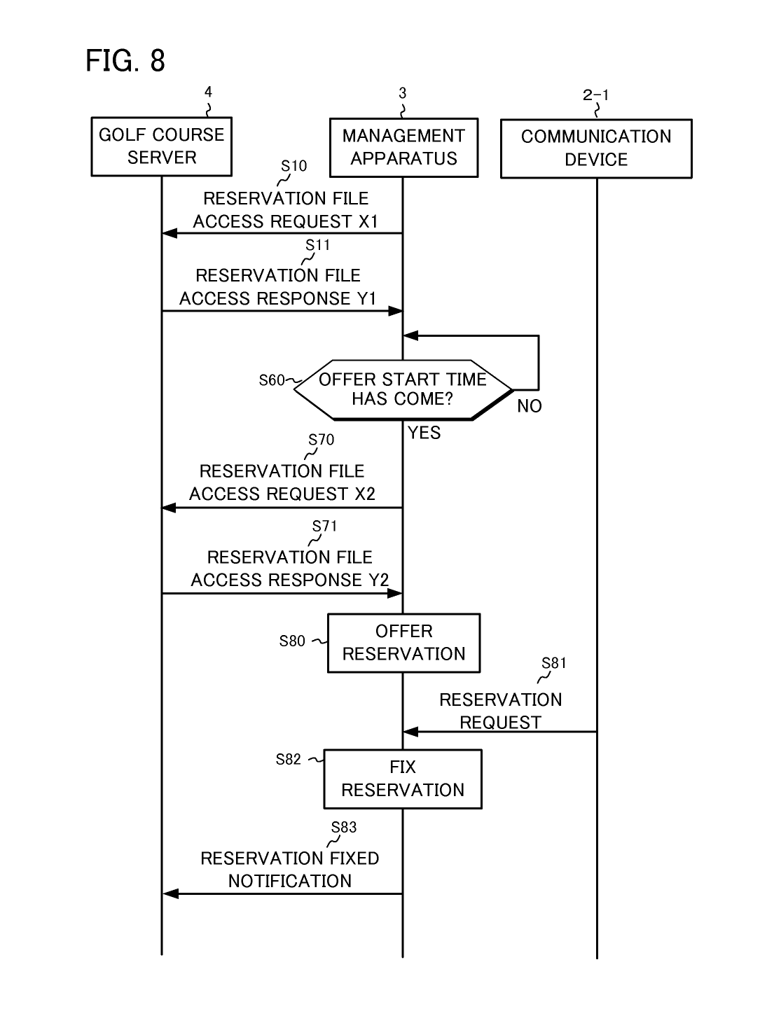

The action of the reservation support system 100 relating to the automatic offer will be described in reference to FIG. 8. In the automatic offer, even if there are no offer requests from the golf course server 4 to the management apparatus 3, the management apparatus 3 automatically offers the reservation for use of the service.

The management apparatus 3 sends a reservation file access request X1 to the golf course server 4 (S10). The golf course server 4 sends back a reservation file access response Y1 (S11). The reservation file access request X1 contains authentication information to permit access to the unreleased reservation file 4fa. If the authentication information is correct, the golf course server 4 sends back a reservation file access response Y1. This can prevent unauthorized access. The reservation file access response Y1 contains the reservation file 4fa when sent back. Then, the management apparatus 3 acquires the reservation file 4fa to refer to the offer start time information of each record contained in the reservation file 4fa.

Next, the management apparatus 3 determines whether or not the offer start time has come (S60). If the offer start time has come, the management apparatus 3 sends a reservation file access request X2 to the golf course server 4 (S70). The golf course server 4 receives the reservation file access request X2 to send back a reservation file access response Y2 to the management apparatus 3 (S71). The reservation file access request X2 contains authentication information, and the reservation file access response Y2 contains the reservation file 4fa, in the same way as the reservation file access request X1 and the reservation file access response Y1.

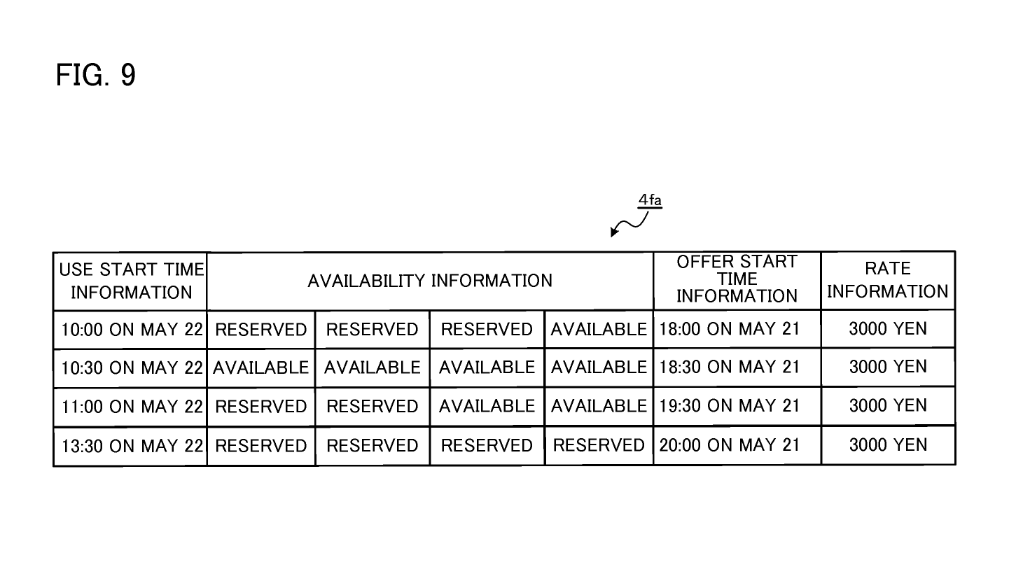

For example, assuming that the reservation file contained in the reservation file access response Y1 is the same as that shown in FIG. 2, and that the present time is “18:00 on May 21.” In this case, since the offer start time of the record with the use start time of 10:00 on May 22 is 18:00 on May 21, the management apparatus 3 sends the reservation file access request X2 to the golf course server 4. It is assumed that the management apparatus 3 has acquired the reservation file 4fa shown in FIG. 9. In this case, in the first acquired reservation file shown in FIG. 2, the record with the use start time of 10:00 on May 22 has two player openings. However, the record shown in FIG. 9 has one player opening. This is because between the receipt times of the reservation file access responses Y1 and Y2, a member of the golf course has made the reservation for one person at the golf course, and the reservation file 4fa has been updated in the golf course server 4.

Then, as shown in FIG. 8, the management apparatus 3 offers the reservation for use of the service (S80). Specifically, the management apparatus 3 provides information on the offer of the reservation for use of the service through the Internet 1.

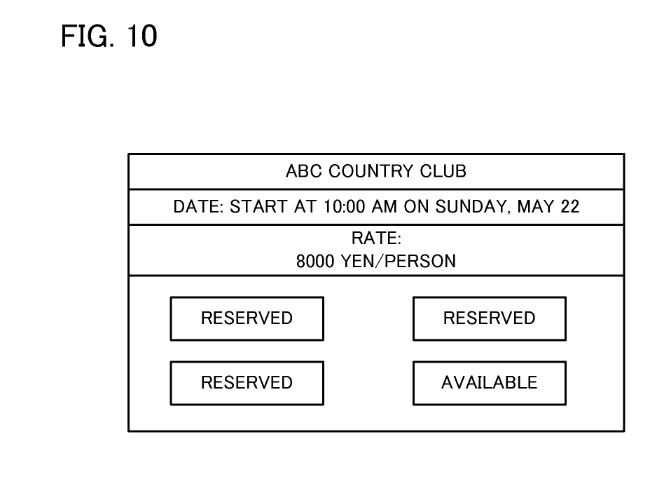

In this case, the information may or may not be provided exclusively to the members of the SNS. When acquiring the reservation file shown in FIG. 9, for example, the management apparatus 3 releases information including for example, player openings corresponding to the number of persons, who are available for use of the service, and the rate set for each of the player openings (in this example, a single rate of 3000 yen) through the Internet 1, as shown in FIG. 10. This enables the members of the SNS to know that the reservation for use of the service is offered.

In the example shown in FIG. 8, the communication device 2-1 sends a reservation request to the management apparatus 3 (S81). The reservation request includes reservation request information containing the member ID of the member of SNS who requests the reservation for the player opening When receiving the reservation request, the management apparatus 3 checks the member ID to fix the reservation for the player opening (S82). Specifically, a status of the player opening specified in the reservation request information is changed from “available” to “reserved”. In the example shown in FIG. 10, among four player openings, the player opening displayed as “Available” is changed to “Reserved.” As a result, since all the player openings have been reserved, the management apparatus 3 sends a reservation fixed notification indicating that the reservation has been fixed, to the golf course server 4 (S83).

As described above, according to the reservation support system 100 of the present embodiment, the management apparatus 3 accesses the reservation file 4fa to gain the reservation status of the player openings secured for the members of the golf course. The management apparatus 3 starts the offer automatically after the elapse of the time from which the offer to the public is available. As a result, the administrator of the golf course server 4 is able to save time in making the offer of reservations for the player openings to the public, so that the rate of use of the golf course can be increased more effectively.

Furthermore, the management apparatus 3 accesses the reservation file 4fa in the golf course server 4 to fix the content of the offer when the offer start time has come, so that reservation statuses of the reservations by the members of the golf course, which vary from hour to hour, are able to be accurately reflected in the content of the offer.

2. Second embodiment

The reservation support system 100 according to the second embodiment will be described below. The reservation support system 100 of the second embodiment is the same as that of the first embodiment except for the use of a reservation file 4fb instead of the reservation file 4fa and except for the action of the management apparatus 3.

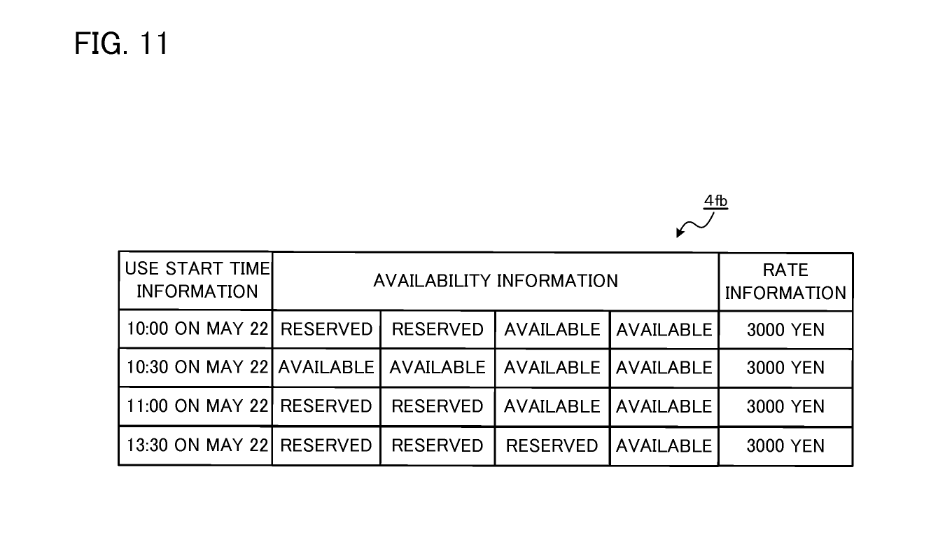

FIG. 11 shows a data structure of the reservation file 4fb. The reservation file 4fb has multiple records. In each of the records, the use start time information, the availability information, and the rate information are associated with each other and recorded. The reservation file 4fb is different from the reservation file 4fa in the respect that the offer start time information is not recorded.

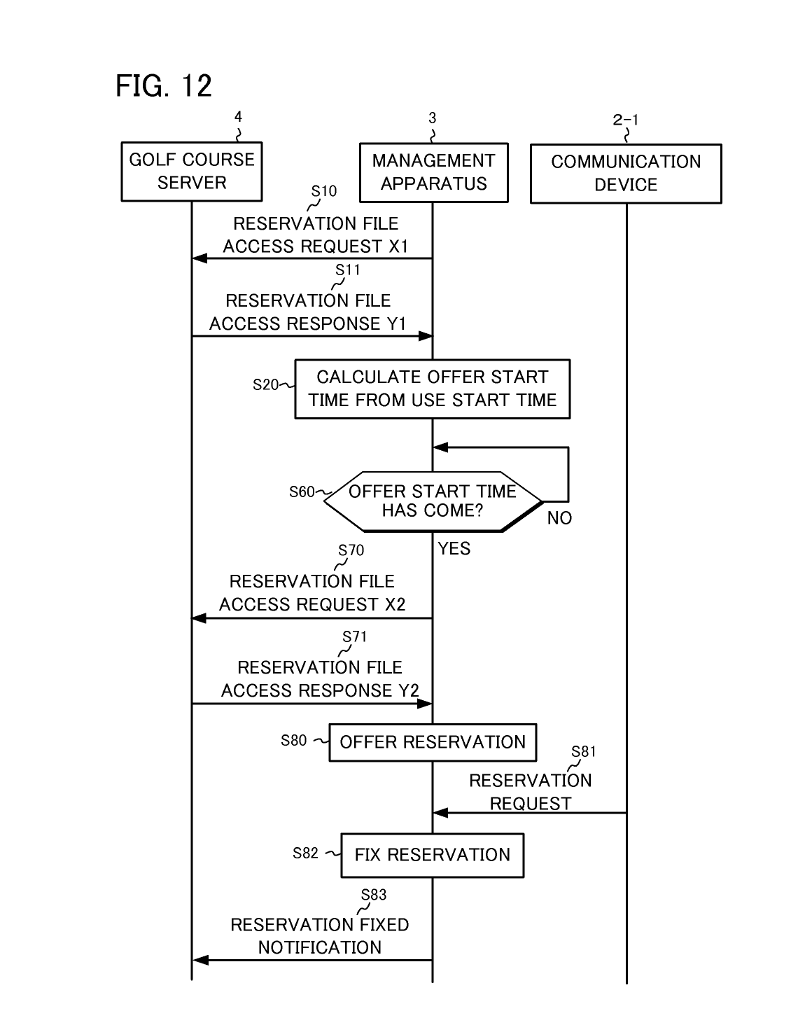

FIG. 12 shows the action of the reservation support system 100 according to the automatic offer of the second embodiment. The reservation file access response Y1 acquired by the management apparatus 3 contains the reservation file 4fb. The reservation file 4fb does not record the offer start time information. The management apparatus 3 subtracts a predetermined time from the use start time to calculate the offer start time (S20). For example, if the predetermined time is 16 hours, the offer start time of the record with the use start time of 10:00 on May 22, is 18:00 on May 21, in the reservation file 4fb shown in FIG. 11. The management apparatus 3 manages the offer start time of each record, so that the management apparatus 3 sends a reservation file access request X2 to the golf course server 4 in the same way as the first embodiment (S70) when the offer start time has come. The management apparatus 3 acquires a reservation file access response Y2 (S71). The management apparatus 3 acquires the availability information by referring to the reservation file 4fb contained in the reservation file access response Y2. As a result, in the present embodiment, the second acquisition unit 31 of the management apparatus 3 accesses the reservation file 4fb to acquire the availability information at a predetermined time before the time indicated by the use start time information. The management apparatus 3 executes the offer of the reservation for use of the service based on the acquired availability information (S80). The predetermined time is specified previously by instruction from the administrator of the golf course server 4.

According to the second embodiment, the management apparatus 3 accesses the reservation file 4fb to calculate the offer start time based on the use start time and the predetermined time, so that the management apparatus 3 automatically starts the offer after the offer start time. As a result, the administrator of the golf course server 4 is able to save time in making the offer of the reservations for the player openings available to the public, so that the use rate of the golf course can be increased more effectively. Furthermore, the administrator of the golf course server 4 does not need to write the offer start time information in the reservation file 4fb, so that the management of the reservation file 4fb can be simplified, and an automatic offer can be simply conducted.

3. Variations

The present invention is not limited to the above-mentioned embodiments. For example, the present invention can be achieved by the following variations. Furthermore, one or more aspects appropriately selected from the following variations can be combined with others.

(1) In each of the above-mentioned embodiments, the management apparatus 3 is provided separately from the golf course server 4, but the present invention is not limited thereto. The management apparatus 3 may be integrated with the golf course server 4.

(2) In the above-mentioned first embodiment, the management apparatus 3 acquires the reservation file 4fa from the reservation file access response Y1, but the present invention is not limited thereto. The management apparatus may acquire only the offer start time information contained in the reservation file 4fa. The management apparatus 3 only has to access the reservation file 4fa in the golf course server 4 to acquire the offer start time information. The management apparatus 3 is not able to acquire the availability information from the reservation file access response Y1, but able to acquire it from the reservation file access response Y2, so that the offer of the reservation for use of the service is executed normally (S80).

(3) In the above-mentioned second embodiment, the management apparatus 3 acquires the reservation file 4fb from the reservation file access response Y1, but the present invention is not limited thereto. The management apparatus may acquire only the use start time information contained in the reservation file 4fb. The management apparatus 3 only has to access the reservation file 4fb in the golf course server 4 to acquire the use start time information. The management apparatus 3 is not able to acquire the availability information from the reservation file access response Y1, but it is able to acquire it from the reservation file access response Y2, so that the offer of the reservation for use of the service is executed normally (S80).

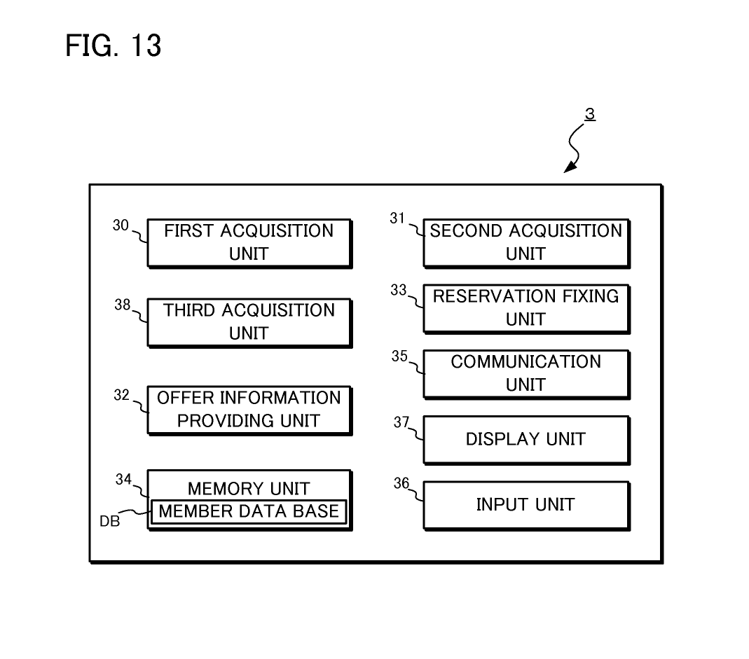

(4) In the first embodiment and the second embodiment as described above, the reservation file 4fa or 4fb in the golf course server 4 in the reservation file access request X1 and the reservation file access response Y1 is accessed to acquire the availability information (El). In this variation, the management apparatus 3 has a function of a third acquisition unit 38 as shown in FIG. 13. The third acquisition unit 38 accesses the reservation file 4fa or 4fb in the golf course server 4 to acquire the availability information until the second acquisition unit 31 acquires the availability information. The third acquisition unit 38 is a functional block achieved by functioning according to a computer program executed by the CPU shown in FIG. 4.

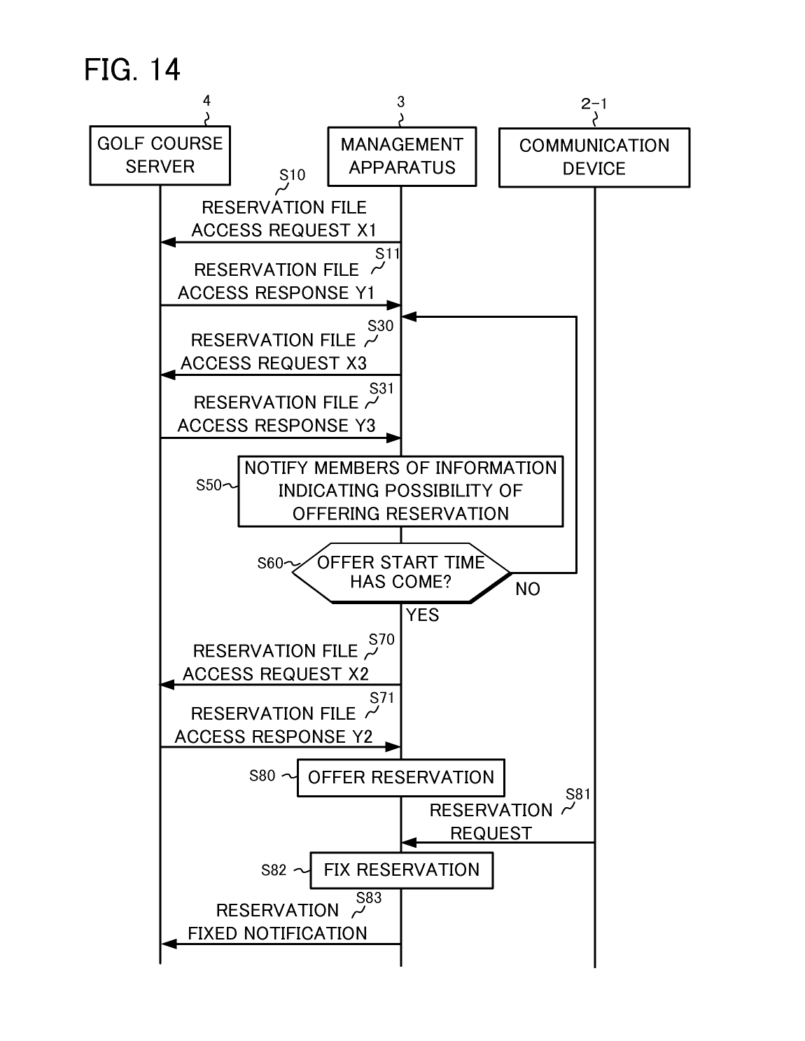

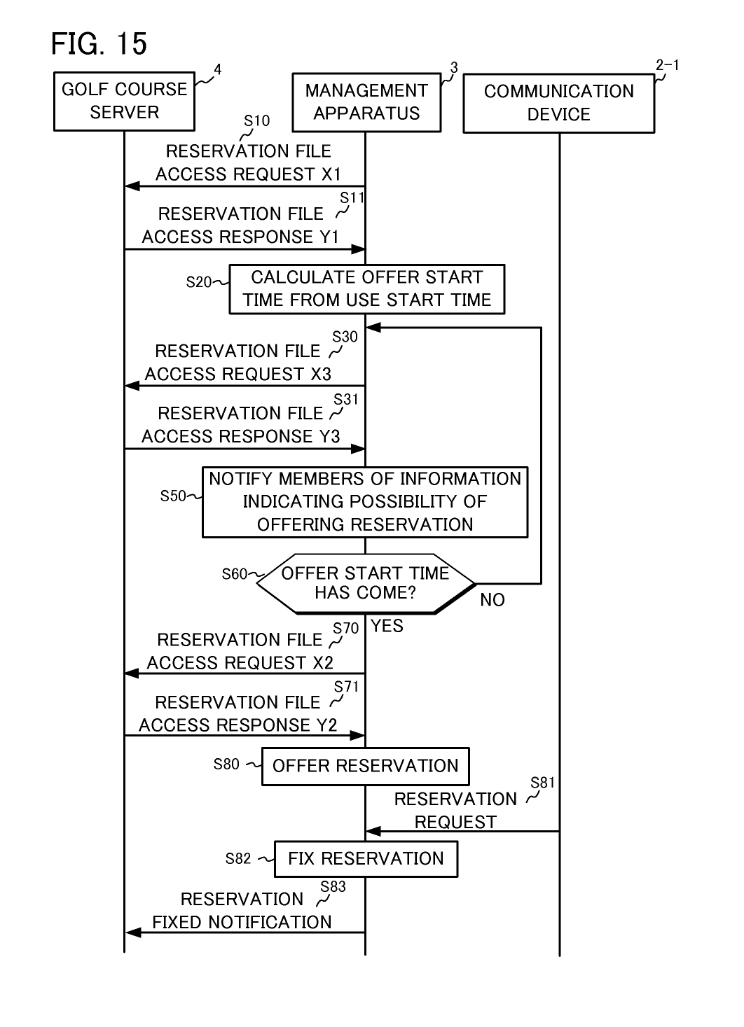

The action of this variation will be described in reference to FIGS. 14 and 15. FIG. 14 is a flow chart corresponding to that of FIG. 8 of the first embodiment. FIG. 15 is a flow chart corresponding to that of FIG. 12 of the second embodiment.

During a period from the time when the availability information (E1) is acquired from the reservation file access response Y1 to the time when the availability information (E2) is acquired from the reservation file access response Y2, the CPU 40 of the management apparatus 3 accesses the reservation file 4fa or 4fb in the golf course server 4 to acquire the availability information (E3). Specifically, as shown in FIG. 14 or 15, the CPU 40 of the management apparatus 3 sends a reservation file access request X3 to the golf course server 4 (S30). The CPU 40 of the management apparatus 3 receives the reservation file access response Y3 from the golf course server 4 (S31). The management apparatus 3 may notify the members of information indicating the possibility of the offering of the reservation for use for the service (S50). The possibility is determined at least based on the availability information (E3). The receipt of the reservation file access request X3 and the reservation file access response Y3 and the notification of information indicating the possibility of offering of the reservation for use of the service do not need to be continuously conducted before the reservation is started, but may be conducted at appropriate intervals.

In this case, when there are player openings for use of the service, the management apparatus 3 refers to an e-mail address in the SNS member database DB to send an email giving the name of the golf course, the use start time, the offer start time, the rate, and the like to the communication device 2 of the member of the SNS. This enables the members of the SNS to know of the possibility of the offering of the reservation for use of the service before the reservation starts, so that reservations in the management apparatus 3 are more likely to be fixed while reservations offered from the golf course server 4 are prioritized.

The notification of the possibility of the offering of the reservation for use of the service may be conducted in the following cases. In a first aspect, the management apparatus 3 estimates the probability of one or more player openings being left at the time when the reservation starts, based on the number of the player openings and the remaining time until the reservation ends, which are specified from the availability information (E3). Then, the management apparatus 3 notifies the members of the probability when the estimated number of the remaining player openings is greater than a predetermined number.

In a second aspect, the management apparatus 3 specifies the increase of the reservation to the elapsed time from the availability information (E1) and (E3) to estimate the probability of one or more player openings being left at the time when the reservation starts. Then, the management apparatus 3 notifies the members of the SNS of the probability when the estimated number of the remaining player openings is greater than a predetermined number.

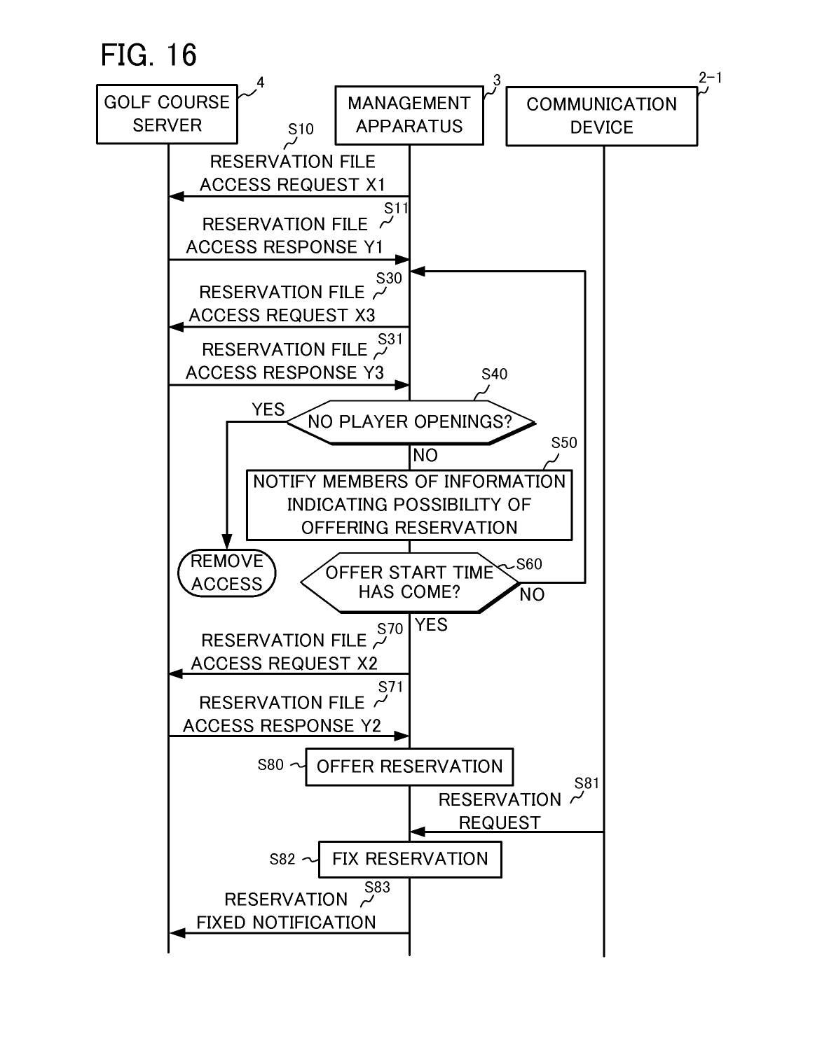

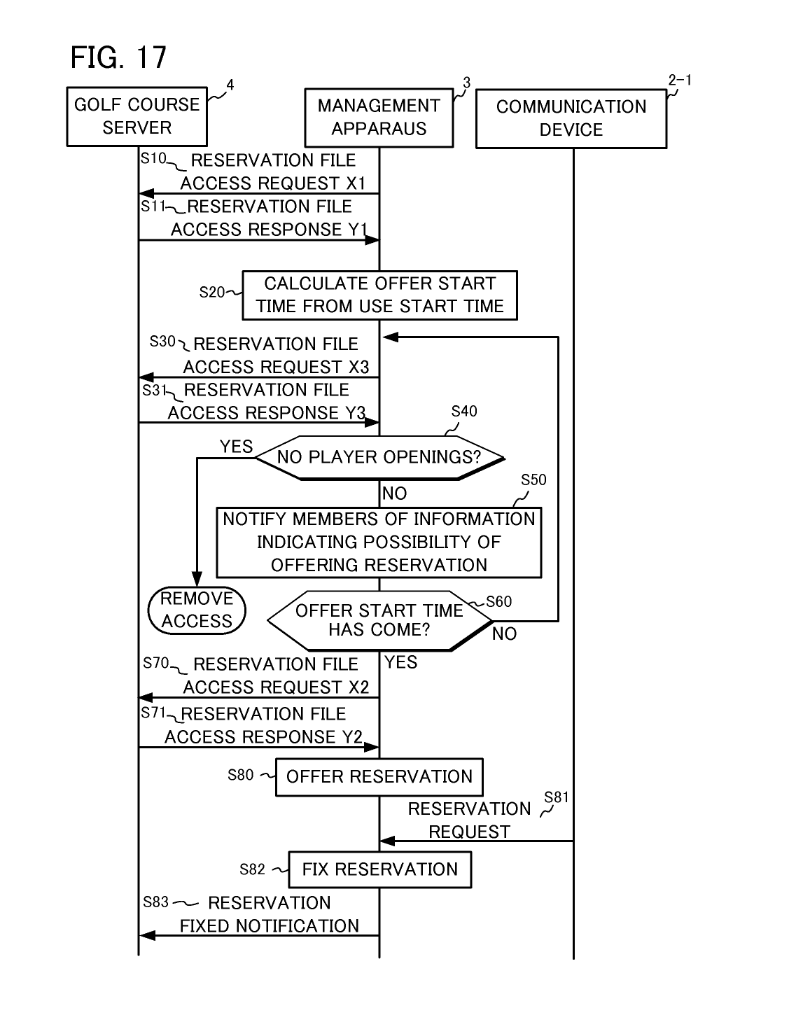

The management apparatus 3 determines whether or not all the player openings are reserved based on the availability information (E3) acquired from the reservation file access response Y3. When the management apparatus 3 determines that there are no player openings, the second acquisition unit 31 of the management apparatus 3 may not send the reservation file access request X2 to the golf course server 4, and may remove access to the reservation file 4fa or 4fb. The action of this variation will be described in reference to FIGS. 16 and 17. FIG. 16 is a flow chart corresponding to that shown in FIG. 14. FIG. 17 is a flow chart corresponding to that shown in FIG. 15.

As shown in FIG. 16 or 17, the CPU 40 of the management apparatus 3 sends the reservation file access request X3 to the golf course server 4 (S30). The management apparatus 3 receives the reservation file access response Y3 from the golf course server 4 (S31). Then, the management apparatus 3 determines whether or not there is the player opening based on the availability information (E3) acquired from the reservation file access response Y3 (S40). When the management apparatus 3 determines that there is no player opening (S40; YES), the second acquisition unit 31 of the management apparatus 3 may not send the reservation file access request X2 to the golf course server 4, and may remove access to the reservation file 4fa or 4fb. This enables the process to be simplified and further prevents useless communication.

(5) In each of the above-mentioned embodiments, the access to the reservation files 4fa and 4fb is to access the content of the reservation file by sending the reservation file access request from the management apparatus 3 and then by receiving a reservation file access response from the golf course server 4. However, the present invention is not limited to these embodiments and may be achieved by any aspects as long as the content of the reservation file can be accessed. For example, the golf course server 4 may authenticate the management apparatus 3 by so-called access control to permit access to the reservation files 4fa and 4fb.

(6) In each of the above-mentioned embodiments, the member of the SNS whose reservation request has been accepted may be allowed to send a discount request for reducing the rate of a remaining player opening to the management apparatus 3 in the offer request and the automatic offer. This discount request contains discount request information indicating the amount of reduction of the rate of the remaining player opening, for which a requester pays, and the member ID of the requester.

When receiving the discount request, the management apparatus 3 determines whether or not the requester is a member of the SNS whose reservation request has been accepted based on the member ID. If the requester is the member of the SNS whose reservation request has been accepted, the management apparatus 3 reduces the rate of the remaining player opening related to the discount request by only the amount indicated in the discount request information, and then updates and releases the offer page.

For example, the amount of reduction may be added to the set rate to be paid in the golf course by the member of the SNS who has sent the discount request. Alternatively, available electronic points for the amount of reduction may be purchased from the website provided from the management apparatus, and then allocated for the payment. The member of the SNS sending the discount request pays the points for the amount of reduction out of previously purchased points to the management apparatus 3. The management apparatus 3 manages the paid points to execute a payment process together with the golf course server 4 when the reservation for use for the service is fixed. When no reservations for use of the service are fixed, the member of SNS whose discount request is accepted only has to be reimbursed in electronic points. Electronic points needed for payment in the discount request are not necessarily purchased in advance and may be purchased when the payment is required.

The management apparatus 3 may have a function of a rate change unit. When the rate changing unit receives discount request information indicating the discount request to reduce the rate set for the player opening from the member of SNS whose reservation request has been accepted, the rate changing unit updates the rate information set for the player opening based on the rate information specified in the discount request information. When there are multiple player openings, the rate can be reduced for each player opening, but may be reduced for all the player openings on one discount request.

In the above-mentioned embodiments, storing the member database DB in the memory unit 34 of the management apparatus 3 is described. However, the present invention is not limited to such an example.

Information in the member database DB stored in the external server device such as the golf course server 4 may be used.

### REFERENCE SIGNS LIST

1 . . . Internet, 2-1 to 2-n. . . communication device, 3 . . . management apparatus, 4 . . . golf course server, DB . . . member database, 4fa, 4fb . . . reservation file

1. A management apparatus adapted for receiving a reservation to communicate with a server device updating a reservation file, in which availability information indicating availability of a reservation for use of a service is recorded, wherein the management apparatus generates offer information on an offer of the reservation for use of the service to provide the offer information through a communication network, and the management apparatus further receives a request for the reservation for use of the service from a member to fix the reservation, the management apparatus comprising:
a first acquisition unit adapted for accessing the reservation file in the server device to acquire offer start time information, which is recorded in the reservation file, and indicates a time from which the offer is available in the management apparatus;
a second acquisition unit adapted for accessing the reservation file in the server device to acquire the availability information after the elapse of the time indicated by the acquired offer start time information;
an offer information providing unit adapted for generating the offer information, which indicates contents of the service, and the availability of the reservation for use of the service, based on the availability information acquired by the second acquisition unit, and for providing the offer information through the communication network; and
a reservation fixing unit adapted for receiving reservation request information, which indicates a reservation request for requesting a reservation for use of the service, from a communication device of the member, and for, if the reservation request is accepted, changing a status of the availability specified in the reservation request information from an available status to a reserved status to fix the reservation.

2. A management apparatus adapted for receiving a reservation to communicate with a server device updating a reservation file, in which availability information indicating availability of a reservation for use of a service is recorded, wherein the management apparatus generates offer information on an offer of the reservation for use of the service to provide the offer information through a communication network, and the management apparatus further receives a request for the reservation for use of the service from a member to fix the reservation, the management apparatus comprising:
a first acquisition unit adapted for accessing the reservation file in the server device to acquire the use start time information, which is recorded in the reservation file, and indicates a time from which the use of the service is available in the management apparatus;
a second acquisition unit adapted for accessing the reservation file in the server device to acquire the availability information at a predetermined time before the time indicated by the acquired use start time information;
an offer information providing unit adapted for generating offer information, which indicates contents of the service, and the availability of the reservation for use of the service, based on the availability information acquired by the second acquisition unit; and
a reservation fixing unit adapted for receiving reservation request information, which indicates a reservation request for requesting a reservation for use of the service, from a communication device of the member, and for, if the reservation request is accepted, changing a status of the availability specified in the reservation request information from a available status to a reserved status to fix the reservation.

3. The management apparatus according to claim 1, wherein the first acquisition unit acquires the availability information together with the offer start time information or the use start time information, the management apparatus further comprising:
a third acquisition unit adapted for accessing the reservation file to acquire the availability information during a period from a time when the first acquisition unit acquires the availability information to a time when the second acquisition unit acquires the availability information; and
a notification unit adapted for notifying the member of information indicating a possibility of the offer of the reservation for use in the service, the possibility being determined at least based on the availability information acquired by the third acquisition unit.

4. The management apparatus according to claim 3 wherein the second acquisition unit removes access to the reservation file when the availability information acquired by the third acquisition unit indicates that there is no openings.

5. A management method executed by a management apparatus adapted for receiving a reservation to communicate with a server device updating a reservation file, in which availability information indicating availability of a reservation for use of a service is recorded, wherein the management apparatus generates offer information on an offer of the reservation for use of the service to provide the offer information through a communication network, and the management apparatus further receives a request for the reservation for use of the service from a member to fix the reservation, the management method comprising:
accessing the reservation file in the server device to acquire offer start time information, which is recorded in the reservation file, and indicates a time from which the offer is available in the management apparatus;
accessing the reservation file in the server device to acquire the availability information after the elapse of the time indicated by the acquired offer start time information;
generating the offer information, in which indicates contents of the service, and the availability of the reservation for use of the service, based on the availability information acquired by the second acquisition unit;
providing the offer information through the communication network;
receiving reservation request information, which indicates a reservation request for requesting a reservation for use of the service, from a communication device of the member; and
if the reservation request is accepted, changing a status of the availability specified in the reservation request information from an available status to a reserved status to fix the reservation.

6. A management method executed by a management apparatus adapted for receiving a reservation to communicate with a server device updating a reservation file, in which availability information indicating a availability of a reservation for use of a service is recorded, wherein the management apparatus generates offer information on an offer of the reservation for use of the service to provide the offer information through a communication network, and the management apparatus further receives a request for the reservation for use of the service from a member to fix the reservation, the management method comprising:
accessing the reservation file in the server device to acquire the use start time information, which is recorded in the reservation file, and indicates a time from which the use of the service is available in the management apparatus;
accessing the reservation file in the server device to acquire the availability information at a predetermined time before the time indicated by the acquired use start time information;
generating offer information, which indicates contents of the service, and the availability of the reservation for use of the service, based on the availability information acquired by the second acquisition unit;
receiving reservation request information, which indicates a reservation request for requesting a reservation for use of the service, from a communication device of the member; and
if the reservation request is accepted, changing a status of the availability specified in the reservation request information from an available status to a reserved status to fix the reservation.

7. The management apparatus according to claim 2, wherein the first acquisition unit acquires the availability information together with the offer start time information or the use start time information, the management apparatus further comprising:
a third acquisition unit adapted for accessing the reservation file to acquire the availability information during a period from a time when the first acquisition unit acquires the availability information to a time when the second acquisition unit acquires the availability information; and
a notification unit adapted for notifying the member of information indicating a possibility of the offer of the reservation for use in the service, the possibility being determined at least based on the availability information acquired by the third acquisition unit.

8. The management apparatus according to claim 7 wherein the second acquisition unit removes access to the reservation file when the availability information acquired by the third acquisition unit indicates that there is no openings.
